(19) United States
(12) Patent Application Publication
(10) Pub. No.: US 2008/0155701 A1
(43) Pub. Date: Jun. 26, 2008

(54) METHOD AND SYSTEM FOR UNAUTHORIZED CONTENT DETECTION AND REPORTING

(75) Inventors: Ronald Martinez, San Francisco, CA (US); Kristina Dinerman, San Francisco, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/615,673

(22) Filed: Dec. 22, 2006

(51) Int. Cl. G06F 21/00

(52) U.S. Cl. 726/27

(57) ABSTRACT

Systems and methods have been developed for detecting the use of rights in media, for example, where the use is based on a content file's presentation on a network. Systems and methods have been developed for determining likely rights owners for content files. Systems and methods may detect and report such use to a purported owner of the rights. Systems and methods have also been developed for offering these rights owners structured, up-to-date online reviewing of the content files, takedown options with respect to the content files, and options to claim revenue generation related to the content files. These systems and methods may control the use of the content file on a network through charging royalties, distributing advertising revenues associated with the content file to the owner, attributing the content file to the owner, restricting access to the content file, using legal action, or through other techniques.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

There are a number of online repositories of content files which allow users to access content files, to search for content files, and to upload content files. On many online repositories, users upload content files which infringe on rights in media items owned by other users. On many online repositories, users may upload content files, or register the content files with the repositories and link to another server which actually stores and serves the content file. A user who own rights in a media item may not be the user who uploads the content file to the repository or server and asks for an action to be performed on the content file which infringes the right in the media item. On most online repositories, the public may access (directly or through linking to another server) a great number of infringing content files.

Owners of media items may be able to track content files online which constitute infringing uses of media items by manually using the same tools as other users to search for the content files. Owners may wish to monitor infringement of their rights in media items with varying degrees of diligence, and may wish to allow some infringing uses while disallowing other infringing uses. Regardless of an owner's interest in being informed about infringement, the efforts rest on the owner for searching for infringing content file on online repositories.

### SUMMARY

Systems and methods have been developed for detecting the use of rights in media, for example, where the use is based on a content file's presentation on a network. Systems and methods have been developed for determining likely rights owners for content files. Systems and methods may detect and report such use to a purported owner of the rights. Systems and methods have also been developed for offering these rights owners structured, up-to-date online reviewing of the content files, takedown options with respect to the content files, and options to claim revenue generation related to the content files. These systems and methods may control the use of the content file on a network through charging royalties, distributing advertising revenues associated with the content file to the owner, attributing the content file to the owner, restricting access to the content file, using legal action, or through other techniques.

In one aspect, the disclosure describes a method which includes receiving from a first user a first identifier of a first content file, and creating an infringement score based on a comparison of the first identifier and one of a plurality of second identifiers, wherein each of the plurality of second identifiers is associated with at least one of a plurality of content files. The method includes, if the infringement score meets an infringement threshold, adding the first identifier to the plurality of second identifiers, and adding the first content file to the plurality of content files. The method includes receiving a third identifier of a media item, wherein the third identifier describes a right in the media item. The method includes creating an identification score based on a comparison of the third identifier and at least one of the plurality of second identifiers, creating a notification score based on the infringement score and the identification score, and notifying an owner of the right in the media item.

In another aspect, the disclosure describes a method which includes receiving a description of a media item, and receiving a request from a user to perform an action on a content file. The method includes receiving a description of the content file from the user, associating the media item with the content file based on a comparison of the description of the content file with the description of the media item, and requesting from an owner approval to perform the action on the content file, wherein the owner owns a right in the media item, wherein the user is different from the owner.

In another aspect, the disclosure describes a system which includes a registration engine which receives a description of a media item and which receives a description of a content file from a user. The system also includes a user interface which receives a request from the user to perform an action on the content file, wherein the user interface requests from an owner of a right in the media item approval to perform the action on the content file, wherein the user is different from the owner. The system also includes a comparison engine which associates the media item with the content file based on a comparison of the description of the content file with the description of the media item.

The following description of various embodiments is merely exemplary in nature and is in no way intended to limit the invention, its application, or uses.

### A BRIEF DESCRIPTION OF THE DRAWINGS

FIG. 1 shows a schematic of an embodiment of a system for detecting and reporting unauthorized content files.

FIG. 2 shows a flow chart of an embodiment of a process for tracking infringement of content files.

FIG. 3 shows a flow chart of an embodiment of a process for notifying an owner of a possibly infringing content file.

FIG. 4 shows a flow chart of an embodiment of a process for moderating an owner's review of and response to a potentially infringing content file.

### DETAILED DESCRIPTION OF THE INVENTION

The following description of various embodiments is merely exemplary in nature and is in no way intended to limit the invention, its application, or uses. While various embodiments have been described for purposes of this specification, various changes and modifications may be made which will readily suggest themselves to those skilled in the art and which are encompassed in the spirit of the invention both disclosed herein and as defined in the appended claims.

End users increasingly redistribute content files through online channels by copying and/or modifying them, and uploading them to online content repositories where they may be found and viewed by others. For example, a content file may be associated with embeddable HTML that other users may use to display the content on other sites. While some of the content may be original material (such as home-made or even professional video, images, or music) other material may include content controlled by copyright or other rights regime by another rights holder, exposing both the uploader and potentially the online repository to potential legal jeopardy.

Review of content files which are uploaded to the online repository can become a daunting task given the number of uploads a given repository experiences. For example, one popular video site reportedly accepts 60,000+ uploaded video clips per day, which equates out to over 20 million clips annually. As the industry is growing for these kinds of services, it can be expected that this volume will rise dramatically in the coming years.

In the United States the Digital Millennium Copyright Act (DMCA), codified as, inter alia, 17 U.S.C. §512 et seq., affords rights owners (e.g., an owner of a right in a media item) the ability to demand of repositories that infringing material be removed from said repositories. However, a rights owner must become aware of the presence of infringing material. Rights owners have the same issues as repositories relating to the numbers of content files uploaded.

Sometimes, there are benefits to a rights owner in having media items in wide circulation via the dissemination of content files containing the media items. Rights owners may disregard infringement in these situations. For example, a new television show that a user believes is worth viewing may be excerpted and uploaded to online repositories. The rights owner may even do this himself. This content file may then be found and may be “passed along” to other potential viewers or published on social networking or other personalized sites. Thus, the spread of a content file can function as a form of marketing for the original media item. However, this practice, if unchecked can easily grow to completely obviating any need to find and experience another version of the media item via another channel (e.g., through purchasing a copy from an online retailer). For example, an entire video program may find its way onto a variety of online repositories, granting access to any user who wishes to view the video program.

Commonly, when users upload a content file, they are asked to provide a title and also one or more identifiers associated with the content file. The identifiers may be tags, keywords, titles, metadata or other identification of the content file. For example, in the process of uploading a content file, a user may entitle a video clip “Goldfinger” to represent the media item contained therein. As another example, the user may entitle the video file “Goldfinger meets Star Wars” if the content file is a “mashup” or combination of media items. The user may provide tags for the content file, such as “goldfinger,” “star wars,” “mashup,” “sean connery,” “harrison,” and/or “ford.”

Users who upload content files may endeavor to make the identifiers accurately descriptive so that other users can easily find the content file when searching for the content files associated with a media item. In addition, a user who uploads a content file may use recognizable identifiers whenever possible because these names attract audiences. Such recognizable identifiers may be those of artists or properties, such as Sean Connery and Goldfinger, respectively. Users may make the identifiers recognizable such that the uploaded content files may be found. A poorly identified content file may fail to receive many views, thus limiting the potential damage of the content file as a result of infringement. For example, an uploaded excerpt of a James Bond film that receives three views has caused some measurable infringing activity, but the monetary damage (or conversely, marketing benefit) to the rights owner is diminished.

In addition, users looking for content files online may search for content files via supplying identifiers to a search engine with access to a catalog of content files. Users may also identify content files containing media items of interest by recognizing identifiers of a content file while browsing (e.g., going through a categorized list).

As used herein, the terms “content file” and “file” may refer to any file or information capable of digital expression. For example, a motion picture may be represented by a content file comprising digital information that, when interpreted by a program or content player, may be perceived by a user. In this example, the term content file may represent the motion picture as perceived, the file comprising the digital information, or the digital information itself. In this example, a differently formatted copy of the motion picture may comprise entirely different information and may be referred to as a different content file. However, it should be understood that the perception of these two motion pictures may be similar and the rights associated with the two content files may overlap and/or be owned by the same owner.

The term media item may refer to an expression which is capable of protection. A particular content file may embody a media item or infringe on a right of the media item. For example, a media item may be a copyrighted and/or trademarked cartoon character. In one embodiment, a media item is a movie, and content files may be segments, bootlegs, remixes, and/or parodies of that movie. There may be media items contained within other media items, for example, characters within a movie may be media items themselves. A content file does not need to represent the same form of expression as the media item in order to infringe a right in the media item. For example, a right in a book or screenplay may be infringed by a movie which is created from that book or screenplay.

As used herein, the term “right” may refer to any right relating to how a media item or content file may be used or accessed, such as access rights (including rights to access a file in the first instance), copyright rights (e.g., display, copy, perform, prepare derivative works), rights made by contract (e.g., a contractual right to use a file for a limited purpose, a software license), trademark rights, common law rights, and patent rights.

As used herein the term “right”, by itself, should be understood as referring to a classification of a type of right rather than a specific piece of intellectual property in a specific media item. For example, the rights owned in a media item may be the full bundle of rights afforded to the creators of media items under applicable copyright laws. In other words, the owner may own a right in one file and may own the same right in another different file. When the term right is used to refer to a specific piece of intellectual property, it will be clearly pointed out which piece of tangible property, e.g., a content file, to which the right pertains.

A right in a media item which is substantially similar, matched, or the same (e.g., for copyright protection purposes) as a particular file may be infringed by the use of that file. There may be many different content files which infringe on a right in a media item. For example, there may be two files in different formats which both infringe a right in a media item because the perception of the two files each substantially invoke the expression of the media item or are substantially similar to the perception of the media item.

If a particular right is non-exclusive in nature, the owner who owns the exclusive right from which the non-exclusive right is derived may sell many copies of the non-exclusive right to many parties. It should be understood that the owner of an exclusive right may own many non-exclusive rights as part of the exclusive right. For example, music compositions may have many non-exclusive licenses sold in them. As another example, the right to print an image one time onto a tangible object, such as paper, a garment, or a canvas, may be sold multiple times to many different users. Rights may expire, be extinguished or be used. For example, a right to print an image or to listen to music may be limited to one such printing or listening, and may be extinguished after the use of the right.

If a right is exclusive, an owner who owns the exclusive right in a media may sell the entirety of the exclusive right in the file only once. In one embodiment, the systems and methods described herein may track sales of rights in files for various purposes, including monitoring which users have purchased rights and the current owners of rights in media items. In one embodiment, the systems and methods described herein monitor and control the exclusive nature of the exclusive rights. In another embodiment, the exclusive nature of the exclusive rights is protected, monitored and controlled by another party. There may be other means of enforcing exclusive rights, such as through a control mechanism when the right is used. For example, a piece of DRM software may contact a server when a file is activated or used. As another example, a playlist of a user may be searched for files stored and/or used by a user.

In one embodiment, a right such as a right to perceive one content file which incorporates a media item, carries with it the same right in another content file. For example, the right to perceive the first file may be given to a user, and that right may allow the user to perceive the second file. For example, a user may buy a right to use a content file he already owns, such as a video file, through acquiring a right to use another content file of the same video.

In another embodiment, a right in one content file does not carry with it the same right in another file. For example, an owner of a right in the first content file may not want a particular version of the one content file to be used or distributed, such as the other content file. The permission to use one content file may be permission only for that version of the content file, such as a master copy. For example, the other content file may be a distorted or reformatted version of a master copy of a content file. In one embodiment, the master copy may be specially formatted by the owner, such as a version containing DRM protection, containing advertisements, or edited a certain way. The other content file may be associated with the content file which is authorized by the owner and may be designated as a content file which is in an unauthorized version.

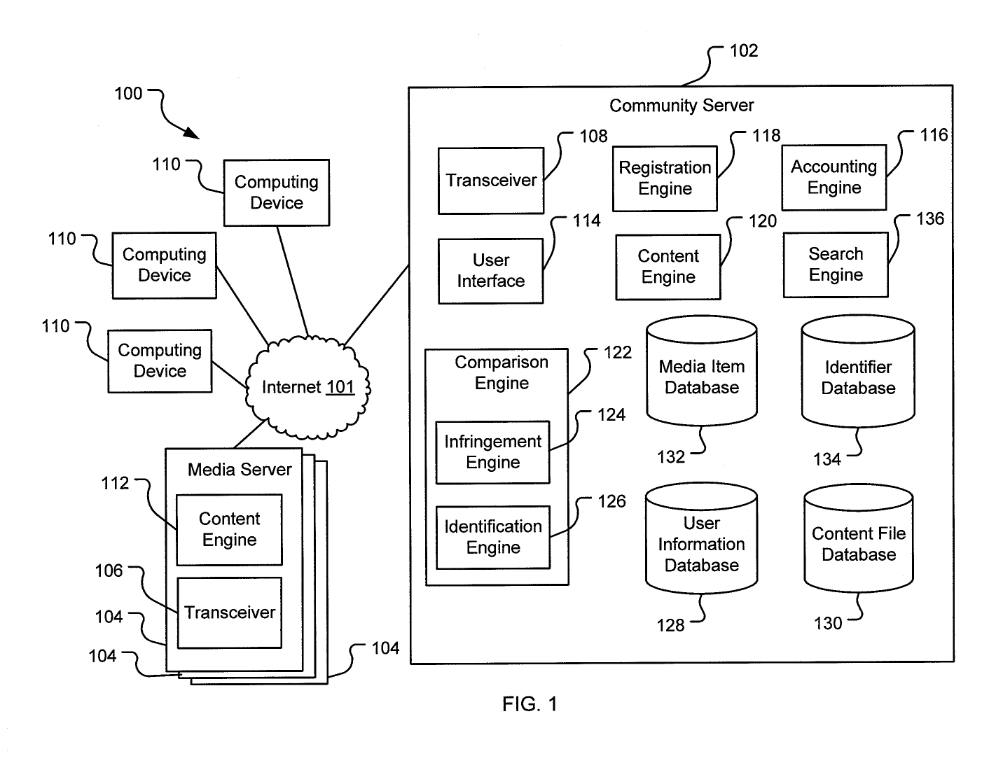

FIG. 1 shows a schematic of an embodiment of a system 100 for detecting and reporting unauthorized content files. A community server 102 is connected with a network, such as the Internet 101. The community server may provide access to content files, and a searching feature to find such content files. Through various implementations of a user interface 114, the community server may interact with a user in a number of different manners. For example, a user may wish to upload a content file and periodically to check on the usage of that content file. As another example, a user may wish to link to another computer through a hyperlink or an embedded piece of software which is associated with a content file. A user may wish to share a content file with other users for free and/or may wish to charge other users or advertisers for the use of the content file. An owner of a right in a media item may wish to monitor content files which may infringe that right in the media item. The community server 102 may facilitate these and other interactions with users (including owners) via various implementations of a user interface 114.

A transceiver 108 may be included in the community server 102 to facilitate transfers of files and other information between the community server and a user. For example, a user may wish to receive a content file over a streaming connection in order to render the content file. As another example, the user may wish to upload information pertaining to a content file, the user's personal information, or communications with other users.

There are many ways in which a user may share content files using the services of a community server, many of which are known by those skilled in the art. In one embodiment, a user uploads a content file to the community server which stores it and shares the content file to users who request the content file, either as a stream or as a download. In another embodiment, a user registers the content file and hosts the content file on a remote server (e.g., media server 104) while the community server redirects users who are interested in perceiving or downloading the content file to the remote server.

The community server may maintain a user information database 128 which may contain many types of information about the users who interact with the community server. Some users may be registered users with the community server, for example, users who have created a user identification (user ID) and profile containing some identifying information such as the user's name and the user's email address. Some users may remain unregistered users, however, the community server may still log user information for unregistered users. In one embodiment, users wishing to interact with the community server must be registered with the community server. In another embodiment, the community server allows unregistered users to upload content files or ask the community server to link to content files hosted on a remote server. In another embodiment, the community server allows an unregistered user a certain limited level of interaction with the community server. The user information database may store any information about a user, such as content file usage history, search history, personal information, demographic information, community server interaction history, and ownership of rights in media items.

A registration engine 118 may take information from a user during a registration process of the user, of a right owned by the user in a media item or at other times. For example, a registration engine 118 may receive information from a user about a media item in which the user owns rights. A user who owns a right in a media item may be discussed herein as an owner of that right in the media item. The registration engine 118 may store the information in a user information database. The registration engine may, during a rights registration process, require information from the owner confirming ownership in the right in the media item, such as through a copyright registration.

In one embodiment, the registration engine may search a database for information relating owners to rights in media items which they may own. For example, there are several online databases and services which track owners of media items, such as a database containing relationships between owners of rights in media items and the identifiers of the media items (e.g., titles of books, titles of movies, names of characters). For example, an identifier of a book (e.g., the James Bond book title “Goldfinger”, the International Standard Book Number or ISBN of the book) can be run against a database containing identifiers of books, the publishers of the book and the likely owner of rights in the book. As another example, publicly accessible movie databases, such as the motion picture industry's Internet Movie Database (IMDB), can provide mappings between likely rights owners and media item titles, names of actors, etc. As another example, a CD Database (CDDB) is offered by Gracenote, Inc. of Emeryville, Calif. (see http://www.gracenote.com/) and provides, among other things, metadata services for media items. As another example, copyright clearinghouses are offered by several vendors which provide identifiers and ownership information related to media items. Some databases are searchable by the rights owner and by the identifier of the content item.

A user using a computing device 110 may use the registration engine 118 to register a content file with the community server. There are a number of ways a user may use the community server to distribute a registered content file to other users over the Internet. The below examples are not exhaustive of the ways known to those with skill in the art.

A user may upload a content file to any of several media servers 104 and may then register the content file with the community server to facilitate other users finding or gaining access to the content file. The media server 104 may then transmit the content file via transceiver 106 to computing devices 110 (e.g., downloading the content file) or to the community server 102. The media server 104 may provide the content file to a computing device 110 in a stream of the content file, for example, through using a content engine 112 within the media server. There are other ways known to those skilled in the art by which the media server 104 may serve a content file to a computing device 110.

The community server 102 may receive a content file uploaded by a user from a computing device 110 through transceiver 108. The community server 102 may store content files in a content file database 130. User information relating to the user who uploaded the content file (regardless of whether the user is registered or unregistered) may be stored within the user information database 128. For example, there may be corresponding user information in the user information database for each content file stored within the content file database.

The community server 102 may include a search engine 136 which allows users to search for content files and media items related to content files. Descriptions of content files and media items may be used by the search engine to aid a user in finding a content file or media item. A description may include one or more identifiers of the content file or media item.

Content files may be searched for by users using a search engine 136, for example, to get a list of content files which all have an identifier included in the search criteria. A search engine 136 may present other identifiers of content files which are returned as part of a search result to aid a user in refining the search criteria. In one embodiment, the search engine 136 may be presented through a user interface 114 as an infringement search engine for an owner looking for infringing files. In another embodiment, the search engine 136 may be used by an owner to test trial identifiers for media items and see if relevant or correct content files are returned. For example, identifiers may be used by users of the community server to mean different things, such as the word “winter” may be used as the name of a movie, book, song, etc.

Identifiers may be used by the community server to compare content files to media items. Identifiers include metadata, tags, titles, keywords, types of content (e.g., video, audiobook, music) or other identifying information of a content file. For example, if a right in a media item has been registered with the “star wars” as an identifier, the same or similar identifier (e.g., “starwarz”) used for a content file may indicate that the content file infringes a right in the media item. The process of comparing identifiers is discussed in more detail with respect to the comparison engine 122.

Identifiers associated with content files and identifiers associated with media items may be stored in an identifier database 134. For example, when a user registers a right in a media item with the registration engine 118, any identifiers associated with the media item or the right therein may be stored in the identifier database. As another example, when a user registers a content file (e.g., uploads it, asks the community server to link to it), the user may be asked by the registration engine (e.g., through a user interface 114) for identifiers to associate with the content file. In one embodiment, identifiers may be received in various forms from a user, for example, an identifier may be determined from various information about the media item or content file, such as a description of the content/media, genre, type of content/media. For example, the title of a content file may be an identifier of the file (e.g., “starwarz.mpg”). In another embodiment, an identifier is assigned automatically, and a user may at a later time modify the identifier.

The community server 102 may modify identifiers for content files and media items. For example, based on usage of a content file, the community server may modify an identifier associated with the content file, such as adding search terms which were used to locate the file. The community server may include an identifier which is a misspelling, an abbreviation, slang, popular lexicon (e.g., “leet speak”), a substitution of numbers for letters, or any other modified language which may be helpful in identification of the content file or media item. Added identifiers may include suggestions by users or by usage patterns of users. For example, a media item may be identified by an owner as “Goldfinger” yet a portion of the public may be able to upload, search for, and download content files which infringe on the media item based on a “g01d_fng3r” identifier. The community server 102 may thus create identifiers for a content file to create appropriate matches between the content and media the identifiers describe.

The community server 102 may create more distorted or less distorted identifiers for inclusion with identifiers received from a user, for example by changing “str-warz” to “Star Wars” or doing the opposite. The community server 102 may offer a user a list of identifiers during a registration process for the purpose of rights registration or a user uploading a content file. The list of identifiers may include modifications of user suggested identifiers or identifiers which are commonly associated therewith. For example, a user suggested identifier may be “Harrison Ford” and the community server may suggest both “Star Wars” and “Indiana Jones” as modifiers which may be included.

The community server may modify the identifier database 134 based on usage patterns of users. For example, if two identifiers are commonly used together (e.g., in searches, as descriptors of content files or media items, in reviews of content files), then the identifiers may be added to lists which only contain one of the identifiers. As another example, an identifier which is not searched for, but is associated with a content item selected from a list of search results may be associated (e.g., added to lists, otherwise linked) with the identifiers used in the search. As another example, identifiers which are used together by owners of media items will be associated when one of the identifiers is used to refer to content files. Multiple databases, including remote databases or information stores accessible by the Internet, may be used by the community server to modify identifiers. For example, reviews written about content files or media items may be used by the community server as sources for identifiers of those content files or media items.

The community server 102 may manage relationships between media items, content files, and the identifiers of both in a number of ways. It should be understood that in the embodiment shown, the community server uses separate databases to manage these relationships, namely a content file database 130, a media item database 132, and an identifier database 134, yet this is only one exemplary embodiment and may be reconfigured in several ways as known by those with skill in the art.

A comparison engine 122 may be used by the community server to manage (e.g., create, analyze, monitor, report) relationships between content files and media items. For example, a comparison engine 122 may be used by the community server to create notification scores which may be used to determine whether to notify an owner that a right in a media item may be infringed by a content file. In one embodiment, the comparison engine may create the notification score from an infringement score and an identification score, which are both discussed below in further detail. In another embodiment, the comparison engine may create the notification score from an identification score alone.

The comparison engine may perform comparisons of scores and thresholds, such as notification scores and notification thresholds. The owner may set a notification threshold which must be reached by the notification score before the owner wishes to be notified. As described herein, scores and thresholds may be scalars, vectors, matrices, categorized values or combinations thereof. Comparisons of scores to thresholds may be a simple scalar comparison (e.g., which is greater) or more complex, such as comparisons involving time-weighting of data, or other mathematical techniques.

Notification scores may be associated with a content file and a media item, and made from the groups of the identifiers associated with the content file and the media item. For example, an overall notification score may be calculated from the group of pairings of each of a number of content files and the media item. In other words, a number of notification scores may be combined into an overall notification score for a group of associated content files and a specific media item. For example, one exact match of identifiers between media item and a content file may create a moderate notification score, and a group of content files matching three identifiers exactly with the same media item may create a high notification score for each of the content files in the group.

An owner may include with a notification threshold other criteria such as ratings, usage, or user information (e.g., data about the users who are using the content files) related to the content file(s) which created the notification score. For example, an owner may be particularly interested whether a group of users is using a file or if the file is particularly popular before being notified whether the file may possibly infringe on the owner's right in a media item.

The community server may notify an owner with alerts that a notification threshold has been met based on the owner's instructions for notification. For example, the community server may notify an owner for each individual content file and media item pair that meets a notification threshold. As another example, the community server may batch notifications together, so that notifications are only received by an owner periodically (e.g., not more often than every week). The community server may notify an owner in one way for one threshold and in another way for another threshold based on the owner's instructions. For example, an owner may want to know immediately if a particular right in a particular media item is infringed, or if there is a particularly high notification score. The owner may request periodic updates for other media items or based on other notification scores.

The exactness of the match between identifiers may affect both identification and infringement scores. For example, if an identifier of a content file is the same as an identifier of a media item, an identification score based on that identifier may be greater than an inexact match between identifiers. Standard text matching techniques may be used such that inexact matches may be detected.

In the comparison engine 122, the identification engine 126 calculates identification scores between content files and media items. In one embodiment, notification scores may be created based solely on identification scores. The identification scores are a measure of the likelihood that a content file is related to a media item. For example, an owner may wish to be notified when an identification score is above a certain value and/or has been increasing for a certain length of time, such as when a content file is related to a media item (e.g., may infringe a right in the media item when the content file is used) and/or when a content file has become more related over time. Relationships between content files and media items and the corresponding identification scores may change over time as identifiers for both are changed (e.g., due to usage information), as described further herein. For example, new content files may be registered with the community server and new identifiers may be added to a content file which may create new infringement scores.

In the comparison engine 122, the infringement engine 124 may calculate infringement scores between content files. An infringement score is a measure of the likelihood that a content file similarly infringes as compared to another content file. This embodiment may be used to associate content files together before an owner of a right in a media item has been registered. Several uses for such pre-identification association of content files exist. For example, a group of content files may be able to share identifiers so that each has a group of relevant and up to date identifiers. Usage data about a group of associated content files may also be aggregated by the community server to provide an overall picture of how the group of associated content files is treated by users.

Associations between groups of files may be broken if the community server determines that one content file diverges from another content file in usage, user-created identifiers, or other indicators. By refining the association between the group of content files, the infringement scores between the content files become more relevant. When a sufficient match with a registered media item is made by one content file, the group of other content files associated with that content file, as well as all of the aggregate data collected about the group of content files may be brought to the attention of the owner.

In one embodiment, the community server 102 may track content files by creating infringement scores between content files separately from an associated media item. Content files may be tracked and grouped through the creation of infringement scores for possible infringing activities independently from an owner's registration of a right in a media item which may be infringed by the use of one of the content files in the group. For example, a content file may be uploaded to the community server which contains user-created content (e.g., a home video), and there may not be a media item then registered with the community server with which to create an identification score. The content file, and its identifiers, may still be tracked by the community server. As described above, the registration engine may register media items and likely owners of rights in those media items by performing a registration process with the owner of the media item, or by retrieving information from a database which contains owner information correlated to media item information.

In one embodiment, infringement scores may be compared to an infringement threshold in order to associate content files together. For example, a community server may want to track associations only if they are of a certain significance. In one embodiment, a community server may adjust an infringement threshold to increase/reduce the number of groupings between content files. In another embodiment, a community server may adapt infringement thresholds based on the number of content files within groupings. A community server may adjust infringement thresholds to create more relevant groupings of content files for owners when they are notified of potentially infringing content files. For example, an owner may wish to see content files which have a strong likelihood of infringing a media item, and to see them grouped according to the media item which they might infringe.

The community server may solicit and receive instructions from an owner about how to create, establish, adapt, or maintain thresholds for both for infringement and identification scores. These instructions may include examples of infringing materials which should meet thresholds. These instructions may be received as part of an interaction which includes the owner requesting sample infringement scores and identification scores to be generated based on a set of identifiers for a sample/hypothetical content file. For example, an owner may wish to set a threshold which will be met by a certain identifier, and thus may request scores to be generated by the identifier or similar identifiers in order to set a threshold. In one embodiment, an owner may wish to set an infringement threshold in order to control the size of the group of content files (e.g., the number and type of content files) which are returned to the owner when an identification threshold is met by an identification score. In another embodiment, an owner may wish to set an identification threshold in order to control the range of content files which are returned as possibly infringing (e.g., return only content files which strongly implicates the use of a right in a media item).

In one embodiment, the community server, including the user information database 128 and the user interface 114 may present the owner with options on how to deal with the potentially infringing content files. The community server may refuse to perform any action on the content file (e.g., an action requested by a user registering the content file) before presenting the content file to an owner of a right which is potentially infringed by the content file. After logging into the community server, an owner may review a content file using the content engine 120 to stream the content file, or may access the content file another way, as described further herein.

An owner may decide to allow an action requested by a user who registered the content file and/or may request the community server to perform a remedial action. The community server may provide options to the owner for remedial actions, such as collecting royalties from use of the content file on the Internet, issuing a legal notice (e.g., take-down notice under the DMCA) on behalf of the owner, replacing the content file with a similar content file containing attribution to the owner, directing to the owner advertising or other ancillary revenues associated with use of the content file, or requiring display of hyperlinks in proximity to the content file which when activated take the user to an online destination of the content owner's specification, such as a credit page or product page. Thus, the remedial action may include some benefit to the owner, which may or may not be in the form of a monetary payment, that is provided in return for the owner's permission to use the content file. For example, an accounting engine 116 may deposit royalties into an account of the owner, and collect those royalties from paying parties, such as advertisers who advertise on the same webpage as where the content file is presented, or users who use the content file. Legal notices may be supported by relevant copyright laws, trademark laws, patent laws, trade secret laws, or other laws. These actions, and the other processes performed in these embodiments by the community server 102, are described further below.

Elements of the systems described herein may be implemented in hardware, software, firmware, any combination thereof, or in another appropriate medium. The systems described herein may implement methods described herein. In addition, methods described herein when implemented in hardware, software, firmware, any combination thereof, or in another appropriate medium may form systems described herein. Therefore, the descriptions of the methods and systems herein supplement each other and may be understood by those with skill in the art as forming a cumulative disclosure.

The methods described herein may be performed by any part of an element of a system described herein. In addition, the methods described herein may be performed iteratively, repeatedly, and/or in parts. In addition, some of the methods or parts of the methods described herein may be performed simultaneously. In addition, elements of the systems described herein may be distributed geographically or functionally in any configuration.

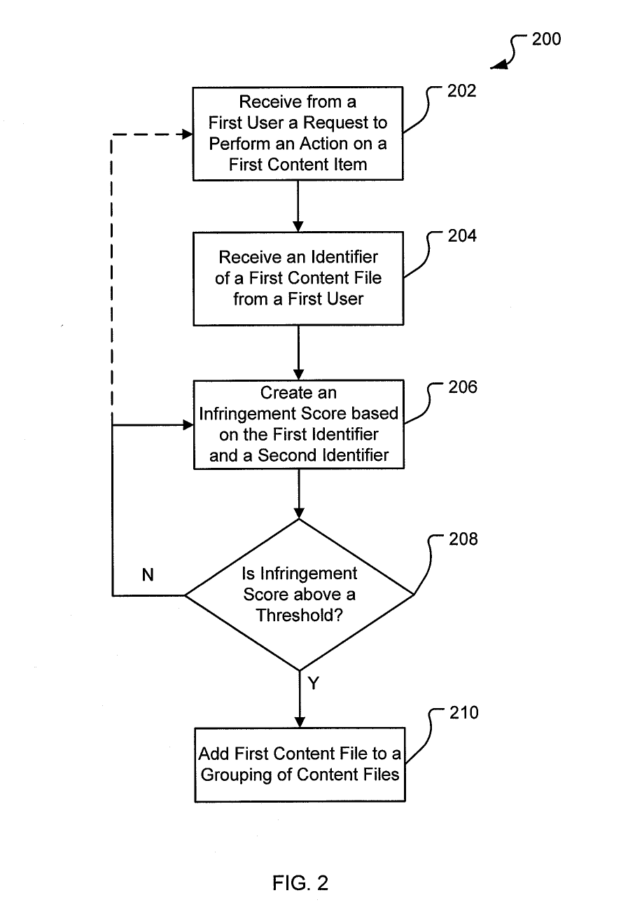

FIG. 2 shows a flow chart of an embodiment of a process 200 for tracking infringement of content files. In the embodiment shown, the process 200 creates infringement scores of content files as they relate to one another based on identifiers of the content files.

A request to perform an action on a content file may be received 202 from a user. The request may be part of a registration process as described herein. For example, the request may be to post the content file for others to stream, download, copy or share with others. The request may be explicitly made by a user or implicitly contained in an action of a user (e.g., uploading the content file to a community server). The request may be received 202 during a larger registration process or could be received at another time, including before or after identifiers are assigned to the content file.

Receiving an identifier 204 from a user for a content file may take place as part of a registration process for the content file. For example, a user may include a description of a file which includes a title and a few keywords to identify the file. As described above, identifiers may be tags, keywords, titles, metadata or other identification of the content file. As also described above, an infringement score may be created 206 between a first identifier of a first content file and a second identifier related to one or more content files which have been associated with each other. As described above, the second identifier may belong to any content file in a grouping of content files, for example, content files which are associated by having high infringement scores between each other. The first content file may be added to (e.g., associated with) the grouping of associated content files 210 if the infringement score meets an infringement threshold. Infringement thresholds are described in greater detail above.

An infringement score may be compared 208 with an infringement threshold to determine whether the infringement threshold is met. If an infringement score created 206 between a first identifier and a second identifier (e.g., pertaining to two content files) is determined 208 not to meet an infringement threshold, then another infringement score may be created 206. Another infringement score may be created 206 between another pair of identifiers (e.g., substituting a new identifier for at least one of the identifiers). For example, another infringement score may be created 206 between other identifiers of the same content files. As another example, another infringement score may be created 206 when new identifiers are added to a list of identifiers for a content file, as described further above. As another example, another infringement score may be created 206 when a new content file is registered, for example by a user requesting 202 that an action be performed on the content file.

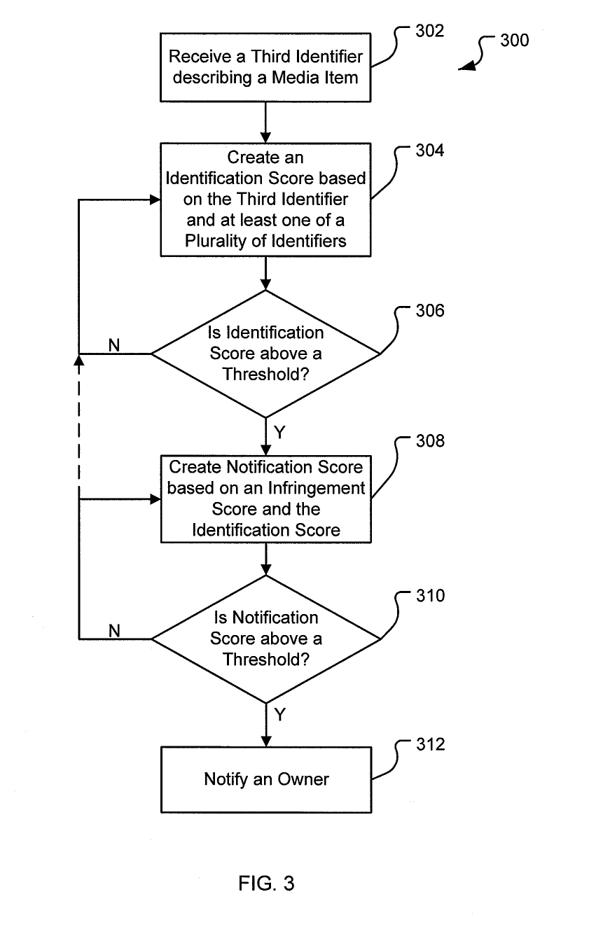

FIG. 3 shows a flow chart of an embodiment of a process 300 for notifying an owner of a possibly infringing content file. In the embodiment shown, the process 300 creates identification score(s) from identifiers of content file(s) and media item(s), and based on the identification score, creates a notification score from an infringement score and the identification score to determine whether to notify the owner. The process may be performed iteratively and repeatedly as will be described further below.

An identifier may be received 302 describing a media item. For example, an owner may register a right in a media item and describe the media item using an identifier. As another example, an identifier of a media item may be retrieved from a database (e.g., an online database) as described above. As described further herein, an identifier may be created for a media item based on the other identifiers of the media item or based on identification scores created 304 between the media item and content items as described further herein.

In the embodiment shown, the identification score is compared 306 with an identification threshold. If the score does not meet the threshold 306, another identification score may be created 304. For example, another identification score may be created using another identifier of the content file. As another example, another identification score may be created 304 from an identifier of another content file. Identification scores, identification thresholds, and comparing 306 the two are described in further detail above.

If an identification score meets an identification threshold, a notification score is created 308 between an identification score and an infringement score. The identification score and the infringement score used to create the notification score 308 may be chosen from any of the scores created between the identifiers of any associated (e.g., grouped) content files and the media item. In one embodiment, a notification score created 308 may use any identifiers from any content files which are associated to each other. In another embodiment, the identifier which created an identification score above the identification threshold is used to create the notification score 308.

Notification scores may be created 308 from an infringement score and an identification score using a number of techniques, including mathematical and statistical techniques. In one embodiment, an infringement score and an identification score are summed to create a notification score. In another embodiment, an infringement score for a group of content files is mathematically weighted (e.g., integrated over time with time-based weighting) as it changes, a number of identification scores each relating to one of the content files and the media item are averaged, and then the weighted infringement score and the averaged identification score are combined to create 308 a notification score.

Different mathematical combinations of infringement scores and identification scores may be used based on the needs of an owner in receiving notification of potential infringement. For example, scores may change based on new files registered with systems and based on changing usage patterns of the registered files. As described further above, a group of infringement scores between content files may change as identifiers of those content files change. In addition, identification scores may change as identifiers of content files change.

If a notification score does not meet a notification threshold 310, other notification scores may be created 308 in similar manners (and based on a similar number of combinations of identifiers) to those discussed above with respect to identification scores and/or infringement scores. In addition, if a notification score does not meet a notification threshold, another identification score may be created 304.

If a notification score meets a notification threshold 310 (e.g., is above a threshold, meets the criteria of a threshold), then the process 300 notifies the owner 312. The notifying 312 of the owner may be performed as described above, including through email, when the owner logs into a community server, when the owner requests to view possible infringing content files, or by other electronic alert. The notification process is described further herein.

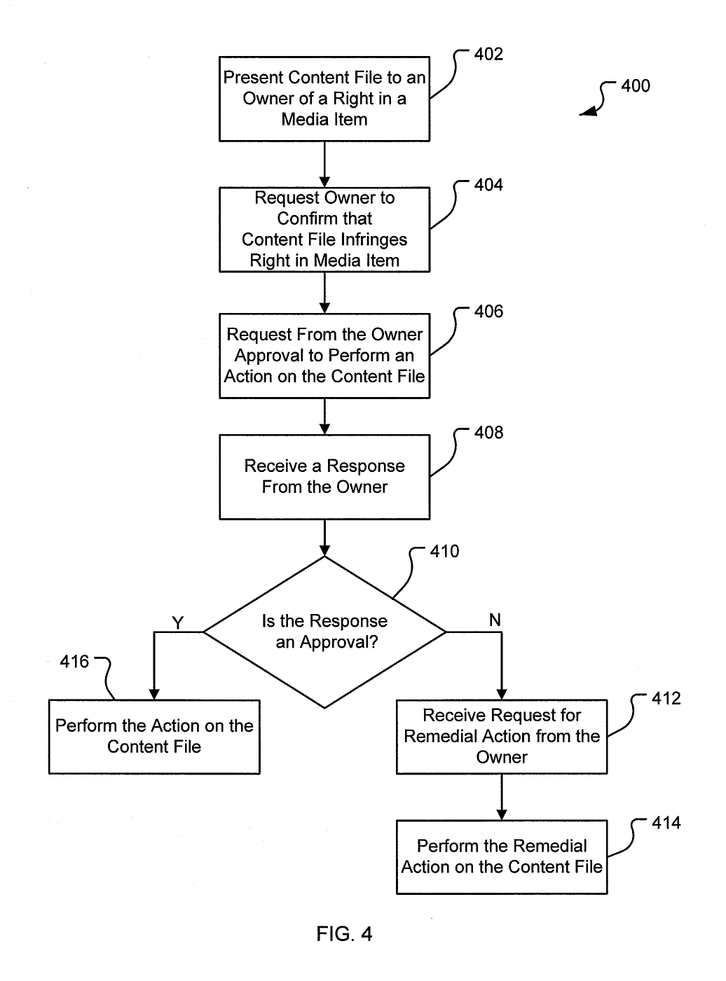

FIG. 4 shows a flow chart of an embodiment of a process 400 for moderating an owner's review of and response to a potentially infringing content file. In the embodiment shown, the process 400 allows an owner to review a content file to confirm that it infringes a right in the media file owned by the owner before deciding whether to allow an action to be performed on the content file or to request that a remedial action be performed.

A content file may be presented to an owner 402 to confirm that it infringes a right in a media item owned by the owner. The presentation of the content file may be, as discussed further herein, through streaming the content file, making the content file available for download, or through other methods known to those skilled in the art. The action requested by the user who registered the content file (e.g., uploaded it) may also be presented to the owner. The actions requested to be performed on the content file are discussed above, such as posting the content file for other users (e.g., the public) to download and/or stream. In one embodiment, the action may be presented to the owner only after the owner requests to review the action. In another embodiment, the action may be included, implicitly or explicitly, in the notification given to the owner.

In one embodiment (not shown), a request may be received from an owner to create an identification and/or notification score from a content file that the owner has not been notified about. For example, an owner may come across a content file which likely infringes a right in a media item owned by the owner. The owner may wish to review identification scores and/or notifications scores (as well as relevant thresholds) in order to investigate why the owner had not been notified about the content file and what can be changed (e.g., identifiers of the media item, thresholds) to cause the owner to be notified in the future. In one embodiment (not shown), the content file or a link thereto may be received from the owner in order to determine whether the notification process (and the identifiers on which it depends) is effective in finding potentially infringing content files.

An owner may be asked 404 to confirm whether the content file infringes a right owned in a media item by the owner. An owner's assertion that a content file infringes a right in a media item owned by the owner may be itself confirmed. For example, a third party may decide whether there is infringement such that the owner's assertion should be upheld. Third parties may include a mediator, representatives of the owner and/or of the user who registered the content file, or a court.

In the embodiment shown, the owner is requested 406 for approval to perform an action on the content file. The action requested by a user to be performed on a content file may have been suspended (e.g., not making the content file accessible by the public) pending approval from an owner or potential owners of the content file. A response may be received from the owner 408 either approving the action 410 to be performed on the content file or requesting a different action 410. The different action may be similar or very close to the action originally requested by the user, yet the owner may wish to modify the action in some way.

Any action requested by the owner 412 which is different from the action originally requested by the user may be termed a remedial action. As described above, remedial actions may include, collecting royalties from use of the content file on the Internet, issuing a legal notice (e.g., take-down notice under the DMCA) on behalf of the owner, replacing the content file with a similar content file containing attribution to the owner, directing to the owner advertising or other ancillary revenues associated with use of the content file, or requiring display of hyperlinks in proximity to the content file which when activated take the user to an online destination of the content owner's specification, such as a credit page or product page. Remedial actions may be in addition to the action originally requested by the user. For example, if a user requested that a content file be posted for sharing (e.g., through social networking methods), a requested remedial action of collecting royalties or advertising revenues from that sharing may include the approval from the owner to perform that sharing.

After approval is received for an action requested by a user, the action may be performed 416. In addition, if a remedial action is requested 412, the remedial action may be performed 414 on behalf of the owner.

The embodiment shown includes one iteration, though there may be many iterations in determining whether the owner owns a right in a media item which is being infringed by a content file and which action should be performed on the content file based on the owner's wishes. For example, a number of content files may be presented to an owner for review. The content files may be associated and so the decisions of the owner with respect to the associated content files may involve several steps of perceiving the various content files and the requested action for each. For example, the owner may wish to see how each content file individually affects the media item and how the content files as a group also affect the media item.

In one embodiment, the owner may request a mock-up version of a website, including a search engine, which represents how the content files would be presented (e.g., shown on a user interface, found via searches) over the Internet if certain actions, remedial or otherwise, were performed on the content files. For example, a owner may request a mock-up of how a website would look and how a search engine would function if the owner allowed one content file to be streamed, blocked another content file, and/or allowed a third content file to be downloaded. In another embodiment, the owner may request to see a side-by-side comparison of mocked-up versions of a website representing how the websites would look and function if actions performed on the content files were allowed, disallowed and/or changed.

1. A method comprising:
receiving from a first user a first identifier of a first content file;
creating an infringement score based on a comparison of the first identifier and one of a plurality of second identifiers, wherein each of the plurality of second identifiers is associated with at least one of a plurality of content files;
if the infringement score meets an infringement threshold, adding the first identifier to the plurality of second identifiers, and adding the first content file to the plurality of content files;
receiving a third identifier of a media item, wherein the third identifier describes a right in the media item;
creating an identification score based on a comparison of the third identifier and at least one of the plurality of second identifiers;
creating a notification score based on the infringement score and the identification score; and
notifying an owner of the right in the media item.

2. The method of claim 1, wherein notifying the owner comprises:
comparing the notification score with a notification threshold; and
if the comparison indicates that the notification score meets the notification threshold, notifying the owner.

3. The method of claim 2, further comprising:
if the comparison indicates that the notification score meets the notification threshold, associating each of the plurality of content files with the owner.

4. The method of claim 1, wherein notifying the owner is performed through transmitting the plurality of second identifiers to the owner.

5. The method of claim 1, wherein notifying the owner is performed in response to receiving from the owner a request to view at least one of the plurality of second identifiers.

6. The method of claim 1, wherein notifying the owner is performed by transmitting an alert to the owner in response to the owner logging on to a community server.

7. The method of claim 1, wherein notifying the owner is performed through sending the owner an electronic message.

8. The method of claim 1, wherein notifying the owner includes transmitting names of each of the plurality of content files to the owner.

9. The method of claim 1, wherein creating the identification score comprises:
determining that the third identifier and the at least one of the plurality of second identifiers are similar.

10. The method of claim 1, wherein the third identifier is received from the owner.

11. The method of claim 1, wherein the third identifier is received from a database over a publicly accessible network.

12. The method of claim 11, further comprising:
transmitting a request over the publicly accessible network for the third identifier to the database.

13. The method of claim 1, wherein the first identifier is a tag.

14. The method of claim 1, wherein the first identifier is a type of content.

15. The method of claim 1, wherein the first identifier is a piece of metadata.

16. The method of claim 1, wherein the first identifier is a title.

17. The method of claim 1, further comprising:
receiving from the first user a request to perform a first action on the first content file; and
if the notification score meets the notification threshold, requesting from the owner approval to perform the first action on the first content file;
else, performing the first action on the first content file.

18. The method of claim 17, further comprising:
receiving an approval from the owner to perform the first action on the first content file; and
performing the first action on the first content file.

19. The method of claim 18, further comprising:
depositing a portion of revenues generated from performing the first action on the first content file into an account of the owner.

20. The method of claim 17, further comprising:
receiving a response from the owner, wherein the response is a denial of the request to perform the first action on the first content file.

21. The method of claim 20, wherein the response includes a request from the owner to perform a remedial action with respect to the content file.

22. The method of claim 21, wherein the remedial action comprises a benefit to the owner.

23. The method of claim 21, wherein the remedial action includes requesting from the first user a payment in return for permission to perform the first action on the content file.

24. The method of claim 21, wherein the remedial action includes requesting from the first user a portion of revenues received by the first user derived from performing the first action.

25. The method of claim 21, wherein the remedial action includes requesting from the first user a portion of advertising revenues received by the first user derived from performing the first action.

26. The method of claim 21, wherein the remedial action includes requesting the first user to add an attribution defined by the owner in return for approval to perform the first action.

27. The method of claim 21, wherein the remedial action includes issuing a legal notice to a server which hosts the content file on the publicly accessible network.

28. The method of claim 27, wherein the legal notice is a notice to restrict access to the content file.

29. The method of claim 27, wherein the legal notice is authorized under the Digital Millennium Copyright Act.

30. The method of claim 21, wherein the remedial action includes modifying the content file to include ownership information which identifies the owner.

31. The method of claim 21, wherein the remedial action includes linking the content file to an online destination chosen by the owner.

32. The method of claim 21, wherein the remedial action includes replacing the content file with a replacement content file, the method further comprising:
receiving the replacement content file from the owner.

33. The method of claim 21, further comprising:
performing the remedial action with respect to the content file.

34. The method of claim 1, further comprising:
receiving the first content file from the first user.

35. The method of claim 1, further comprising:
presenting the first content file to the owner.

36. The method of claim 35, wherein presenting includes rendering the content file for the owner.

37. The method of claim 35, wherein presenting includes making the content file available for downloading by the owner.

38. The method of claim 35, further comprising:
transmitting the content file to the owner.

39. The method of claim 35, further comprising:
receiving verification from the owner that the content file infringes the right in the media item.

40. The method of claim 1, further comprising:
receiving from a second user the at least one of the plurality of second identifiers which is associated with a second content file;
wherein the second user is different from the first user.

41. The method of claim 40, wherein the second content file is different from the first content file.

42. The method of claim 40, further comprising:
receiving from the second user a request to perform a second action on the second content file;
adding the second content file to the plurality of content files; and
if the notification score meets the notification threshold, requesting from the owner approval to perform the second action on the second content file;
else, performing the second action on the second content file.

43. A method comprising:
receiving a description of a media item;
receiving a request from a user to perform an action on a content file;
receiving a description of the content file from the user;
associating the media item with the content file based on a comparison of the description of the content file with the description of the media item; and
requesting from an owner approval to perform the action on the content file, wherein the owner owns a right in the media item, wherein the user is different from the owner.

44. The method of claim 43, wherein requesting comprises:
transmitting the description of the content file to the owner.

45. The method of claim 43, wherein requesting is performed in response to receiving from the owner a request to view the description of the content file.

46. The method of claim 43, wherein requesting is performed by transmitting an alert to the owner in response to the owner logging on to a community server.

47. The method of claim 43, wherein requesting is performed through sending the owner an electronic message.

48. The method of claim 43, wherein requesting includes transmitting the description of the content file to the owner.

49. The method of claim 43, wherein creating the identification score comprises:
determining that the description of the media item and the description of the content file are similar.

50. The method of claim 43, wherein the description of the media item is received from the owner.

51. The method of claim 43, wherein the description of the media item is received from a database over a publicly accessible network.

52. The method of claim 51, further comprising:
transmitting a request over the publicly accessible network for the description of the media item to the database.

53. The method of claim 43, wherein the description of the content file is a tag

54. The method of claim 43, wherein the description of the content file is a type of content.

55. The method of claim 43, wherein the description of the content file is a piece of metadata.

56. The method of claim 43, wherein the description of the content file is a title.

57. The method of claim 43, wherein associating the media item with the content file includes determining whether the description of the content file indicates that the action infringes the right in the media item.

58. The method of claim 57, wherein determining includes creating an identification score using the description of the content file and the description of the media item, wherein the identification score represents a likelihood that the action infringes the right in the media item.

59. The method of claim 43, wherein the description of the media item is the tag.

60. The method of claim 43, wherein the description of the media item is the piece of metadata.

61. The method of claim 43, wherein the description of the media item is the title.

62. The method of claim 43, wherein the action is selected from emailing, posting, modifying, editing, linking to, rendering, storing.

63. The method of claim 43, wherein the requesting is performed through sending an email to the owner.

64. The method of claim 43, wherein the requesting is performed in response to the user logging on to a community server.

65. The method of claim 43, further comprising:
receiving an approval from the owner to perform the action on the content file; and
performing the action on the content file.

66. The method of claim 65, further comprising:
depositing a portion of revenues generated from performing the action on the content file into an account of the owner.

67. The method of claim 43, further comprising:
receiving a response from the owner, wherein the response is a denial of the request to perform the action on the content file.

68. The method of claim 67, wherein the response includes a request from the owner to perform a remedial action.

69. The method of claim 68, wherein the remedial action comprises a benefit to the owner.

70. The method of claim 68, wherein the remedial action includes requesting from the user a payment in return for permission to perform the action on the content file.

71. The method of claim 68, wherein the remedial action includes requesting from the user a portion of revenues received by the user derived from performing the action.

72. The method of claim 68, wherein the remedial action includes requesting from the user a portion of advertising revenues received by the user derived from performing the action.

73. The method of claim 68, wherein the remedial action includes requesting the user to add an attribution defined by the owner in return for approval to perform the action.

74. The method of claim 68, wherein the remedial action includes contacting the user.

75. The method of claim 68, wherein the remedial action includes contacting the user to request from the user a payment in return for permission to perform the action on the content file.

76. The method of claim 68, wherein the remedial action includes issuing a legal notice to a server which hosts the content file on the publicly accessible network.

77. The method of claim 76, wherein the legal notice is a notice to restrict access to the content file.

78. The method of claim 76, wherein the legal notice is authorized under the Digital Millennium Copyright Act.

79. The method of claim 68, wherein the remedial action includes modifying the content file to include ownership information which identifies the owner.

80. The method of claim 68, wherein the remedial action includes linking the content file to an online destination chosen by the owner.

81. The method of claim 68, wherein the remedial action includes replacing the content file with a replacement content file, the method further comprising:
receiving the replacement content file from the owner.

82. The method of claim 68, further comprising:
performing the remedial action with respect to the content file.

83. The method of claim 43, further comprising:
receiving the content file from the user.

84. The method of claim 43, further comprising:
presenting the content file to the owner.

85. The method of claim 84, wherein presenting includes rendering the content file for the owner.

86. The method of claim 84, wherein presenting includes making the content file available for downloading by the owner.

87. The method of claim 86, further comprising:
transmitting the content file to the owner.

88. The method of claim 84, further comprising:
receiving verification from the owner that the content file infringes the right in the media item.

89. A system comprising:
a registration engine which receives a description of a media item and which receives a description of a content file from a user;
a user interface which receives a request from the user to perform an action on the content file;
wherein the user interface requests from an owner of a right in the media item approval to perform the action on the content file, wherein the user is different from the owner; and
a comparison engine which associates the media item with the content file based on a comparison of the description of the content file with the description of the media item.

90. The system of claim 89, wherein the registration engine receives the description of the media item from the owner.

91. The system of claim 89, wherein the registration engine receives the description of the media item from a database over a publicly accessible network.

92. The system of claim 91, further comprising:
wherein the registration engine transmits to the database a request over the publicly accessible network for the description of the media item.

93. The system of claim 89, wherein the comparison engine associates the media item with the content file via determining whether the description of the content file indicates that the action infringes the right in the media item.

94. The system of claim 89, wherein the comparison engine creates an identification score using the description of the content file and the description of the media item, wherein the identification score represents the likelihood that the action infringes the right in the media item.

95. The system of claim 89, wherein the description of the media item is the tag.

96. The system of claim 89, wherein the description of the media item is the piece of metadata.

97. The system of claim 89, wherein the description of the media item is the title.

98. The system of claim 89, wherein the action is selected from emailing, posting, modifying, editing, linking to, rendering, storing.

99. The system of claim 89, wherein the user interface receives an approval from the owner to perform the action on the content file.

100. The system of claim 99, further comprising:
an accounting engine which deposits a portion of revenues generated from performing the action on the content file into an account of the owner.

101. The system of claim 89, wherein the user interface receives a response from the owner, wherein the response is a denial of the request to perform the action on the content file.

102. The system of claim 101, wherein the response includes a request from the owner to perform a remedial action with respect to the content file.

103. The system of claim 102, wherein the remedial action comprises a benefit to the owner.

104. The system of claim 102, wherein the remedial action includes requesting from the user a payment in return for permission to perform the action on the content file.

105. The system of claim 102, wherein the remedial action includes requesting from the user a portion of revenues received by the user derived from performing the action.

106. The system of claim 102, wherein the remedial action includes requesting from the user a portion of advertising revenues received by the user derived from performing the action.

107. The system of claim 102, wherein the remedial action includes requesting the user to add an attribution defined by the owner in return for approval to perform the action.

108. The system of claim 102, wherein the remedial action includes contacting the user.

109. The system of claim 102, wherein the remedial action includes contacting the user to request from the user a payment in return for permission to perform the action on the content file.

110. The system of claim 102, wherein the remedial action includes issuing a legal notice to a server which hosts the content file on the publicly accessible network.

111. The system of claim 110, wherein the legal notice is a notice to restrict access to the content file.

112. The system of claim 110, wherein the legal notice is authorized under the Digital Millennium Copyright Act.

113. The system of claim 102, wherein the remedial action includes modifying the content file to include ownership information which identifies the owner.

114. The system of claim 102, wherein the remedial action includes linking the content file to an online destination chosen by the owner.

115. The system of claim 102, wherein the remedial action includes replacing the content file with a replacement content file, the method further comprising:
receiving the replacement content file from the owner.

116. The system of claim 89, wherein the user interface receives the content file from the user.

117. The system of claim 89, wherein the user interface presents the content file to the owner.

118. The system of claim 117, wherein the user interface presents the content file by rendering the content file for the owner.

119. The system of claim 117, wherein the user interface presents the content file by making the content file available for downloading by the owner.

120. The system of claim 117, wherein the user interface receives verification from the owner that the content file infringes the right in the media item.
